(19) United States
(12) Patent Application Publication
(10) Pub. No.: US 2024/0377770 A1
(43) Pub. Date: Nov. 14, 2024

(54) TONER, IMAGE FORMING APPARATUS, IMAGE FORMING METHOD, AND METHOD OF MANUFACTURING PRINTED MATTER

(71) Applicants: Yoshitaka Yamauchi, Shizuoka (JP); Masayuki Ishii, Shizuoka (JP); Kohtaroh Ogino, Shizuoka (JP); Ayaka Mori, Shizuoka (JP); Shimpei Miyata, Shizuoka (JP)

(72) Inventors: Yoshitaka Yamauchi, Shizuoka (JP); Masayuki Ishii, Shizuoka (JP); Kohtaroh Ogino, Shizuoka (JP); Ayaka Mori, Shizuoka (JP); Shimpei Miyata, Shizuoka (JP)

(73) Assignee: Ricoh Company, Ltd., Tokyo (JP)

(21) Appl. No.: 18/658,331

(22) Filed: May 8, 2024

(30) Foreign Application Priority Data
May 12, 2023 (JP) 2023-079209

(51) Int. Cl. G03G 9/087; G03G 9/08

(52) U.S. Cl. CPC G03G 9/08782; G03G 9/0819; G03G 9/0823; G03G 9/0827; G03G 9/08755

(57) ABSTRACT

A toner is provided that comprises an amorphous polyester resin, a wax, and an external additive, in which the external additive comprises a partially-metal-hydroxide-coated silica that is a silica partially coated with a metal hydroxide, and the partially-metal-hydroxide-coated silica has a hydrophobicity degree of 55 (MeOH %) or more.

### CROSS-REFERENCE TO RELATED APPLICATIONS

This patent application is based on and claims priority pursuant to 35 U.S.C. § 119 (a) to Japanese Patent Application No. 2023-079209, filed on May 12, 2023, in the Japan Patent Office, the entire disclosure of which is hereby incorporated by reference herein.

### BACKGROUND

### Technical Field

The present disclosure relates to a toner, an image forming apparatus, an image forming method, and a method of manufacturing a printed matter.

### Related Art

In recent years, in addition to saving energy as demanded conventionally, there has been a demand for improving the fixability of toners at low temperatures, for the purpose of suppressing volatile components of small particles. In particular, it is desired to achieve both low-temperature fixability (“low-temperature fixability”) and heat-resistant storage stability. It is also desired to maintain a stable charging level over a long period of time and maintain image quality.

Therefore, it is desired to consider the design in the preparation of a toner base, and the selection of external additives.

On the other hand, in recent years, there has been a trend to employ safer materials, and external additives are being searched to replace titanium oxide which is used conventionally.

When titanium oxide is not used, it is difficult to control the charge amount, and it is difficult to ensure stability of the charge amount during long-term use. Further, changes in the physical properties of the external additive may also induce the generation of abnormal images due to toner that is not properly cleaned.

### SUMMARY

Embodiments of the present invention provide a toner comprising an amorphous polyester resin, a wax, and an external additive, in which the external additive comprises a partially-metal-hydroxide-coated silica that is a silica partially coated with a metal hydroxide, and the partially-metal-hydroxide-coated silica has a hydrophobicity degree of 55 (MeOH %) or more.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a part of an image forming apparatus according to one embodiment of the present invention;

FIG. 2 is a schematic diagram illustrating a part of an image forming apparatus according to one embodiment of the present invention;

FIG. 3 is a schematic diagram illustrating an image forming apparatus according to one embodiment of the present invention; and

FIG. 4 is a schematic diagram illustrating a part of the image forming apparatus illustrated in FIG. 3.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to embodiments of the present invention, a toner is provided that has both low-temperature fixability and heat-resistant storage stability, and achieves charging stability and reduction of abnormal images.

Embodiments of the present invention will be described in detail below.

### (Toner)

Embodiments of the present invention provide a toner containing an amorphous polyester resin, a wax, and an external additive. The external additive contains a partially-metal-hydroxide-coated silica that is a silica partially coated with a metal hydroxide, and the partially-metal-hydroxide-coated silica has a hydrophobicity degree of 55 (MeOH %) or more.

The toner according to embodiments of the present invention is able to achieve both low-temperature fixability and heat-resistant storage stability, and achieves charging stability and reduction of abnormal images.

The average circularity of the toner is preferably from 0.930 to 0.960. When the average circularity is within the above-mentioned range, it is easy to adjust transferability and cleanability within an appropriate range.

The average circularity of the toner can be measured by using a known particle measurement device. For example, the average circularity may be measured by using the wet flow-type particle size/shape analyzer FPIA-3000 and the analysis software FPIA-3000 Data Processing Program for FPIA version 00-10 (manufactured by Sysmex Corporation).

Specifically, for example, to a 100 mL glass beaker, 0.1 to 0.5 mL of a 10% aqueous solution of the alkylbenzene sulfonate salt NEOGEN SC-A (manufactured by DKS Co., Ltd.) and 0.1 to 0.5 g of toner or toner base particles are added. Afterwards, the mixture is stirred with a micro spatula and 80 mL of deionized water are added. Next, the mixture is dispersed using an ultrasonic disperser UH-50 (manufactured by SMT Co., Ltd.) for 1 minute under conditions including 20 kHz and 50 W/10 cm³. Subsequently, the mixture is dispersed for a total of 5 minutes to obtain a measurement sample. Here, by using a measurement sample having a particle concentration of 4000 to 8000 particles/10⁻³ cm³, it is possible to measure the average circularity of particles having an equivalent spherical diameter within a desired range.

Note that the average circularity of the base particles of the toner may be used as the average circularity of the toner.

Preferably, the toner further contains a crystalline polyester resin and/or an aromatic petroleum resin.

When the toner contains a crystalline polyester resin, good low-temperature fixability is ensured.

When the toner contains an aromatic petroleum resin, pulverization properties and heat resistance are improved while low-temperature fixability is maintained.

### <External Additives>

The toner of the present embodiment contains an external additive, and thus, the wax in the toner is covered by the external additive, so that deterioration of the transferability and durability caused by the presence of the wax can be prevented. Further, when the surface of the toner is covered with fine particles of the external additive, a contact area between the resin portions contained in the toner particles is reduced. Therefore, fluidity, storage stability, developing properties, transferability, and durability of the toner are improved.

The external additive contained in the toner of the present embodiment contains silica that is at least partially coated with a metal hydroxide (may be referred to as “the silica” or “the partially-metal-hydroxide-coated silica” hereinafter). When the toner contains such silica as an external additive, the charging stability is ensured and the occurrence of abnormal images is prevented.

The hydrophobicity degree of the silica that is at least partially coated with a metal hydroxide is 55 (MeOH %) or more. When the hydrophobicity degree of the silica is less than 55 (MeOH %), an appropriate cleaning performance may not be obtained and abnormal images are likely to occur.

The hydrophobicity degree can be measured by the following method, for example.

First, a beaker is filled with 50 ml of deionized water and 0.2 g of a sample, and methanol is added dropwise while stirring. As the methanol concentration in the beaker increases, the sample gradually settles. The hydrophobicity degree (MeOH %) is defined as the mass fraction of methanol in the mixed solution of methanol and water at the end point when the entire amount of the sample is settled.

The volume resistivity of the silica that is at least partially coated with a metal hydroxide is preferably 1.0E+11 (Ω*cm) or less. When the volume resistivity of the silica is 1.0E+11 (Ω 2*cm) or less, the charging stability can be maintained at a higher level.

The volume resistivity can be measured by the following method, for example.

First, a cell formed by a container made of a fluororesin accommodating two electrodes having a surface area of 2.5 cm×4 cm separated by a distance of 0.2 cm is prepared. The space between the two electrodes is filled with a measurement sample, and tapping is performed 10 times at a dropping height of 1 cm and a tapping speed of 30 times/min. Next, a DC voltage of 1,000 V is applied between the two electrodes filled with the measurement sample, and a resistance value r [Ω] after 30 seconds is measured by using a high resistance meter 4329A (manufactured by Yokogawa Hewlett-Packard Co., Ltd.). By entering the measured resistance value r into the following formula, the volume resistivity [Ω*cm] of the sample can be calculated.

$$r \times ( 2.5 \times 4 ) / 0.2 \qquad ( Formula )$$

Preferably, the partially-metal-hydroxide-coated silica that is at least partially coated with a metal hydroxide, is at least partially coated with an alkylsilane. Thus, it is easy to achieve both a hydrophobicity degree of a certain level or higher and a volume resistivity of a certain level or lower, and the charging stability and the reduction of abnormal images can be maintained at a higher level.

The metal hydroxide is preferably a hydroxide of at least one metal element among aluminum, zinc, iron, and magnesium. When the hydroxides of these metal elements are used, the volume resistivity of the silica can be easily controlled within a desired range.

The average particle diameter of the silica that is at least partially coated with a metal hydroxide is preferably 10 nm to 30 nm. When the average particle diameter of the silica is within the range mentioned above, the surface coating state of the toner can be optimized, and it is easier to achieve both low-temperature fixability and heat-resistant storage stability. Note that the average primary particle diameter of silica particles before being coated with the metal hydroxide may be employed as the average particle diameter of the silica coated with the metal hydroxide.

For example, the average primary particle diameter of silica particles can be determined by acquiring a SEM image of the silica particles using a field emission scanning electron microscope (SU8230, manufactured by Hitachi High-Tech Corporation), and measuring the number average particle diameter by image analysis.

Specifically, for example, a sample of silica particles is dispersed in tetrahydrofuran, and then, the solvent is removed and the sample is dried on a substrate. The sample is observed by using the above-mentioned SEM to acquire an image, and the maximum length of primary particles is measured for each particle under the following measurement conditions. The average primary particle diameter of the silica particles can be obtained by calculating the average value of 50 particles.

### [SEM Measurement Conditions]

Acceleration voltage: 2.0 kV

Working distance (WD): 5.0 mm

Observation magnification: 100000 times

The toner of the present embodiment may contain other fine particles as an external additive, in addition to the silica that is at least partially coated with a metal hydroxide.

As the other fine particles, one or more types among fine inorganic particles, fine inorganic oxide particles, and fine resin particles may be used.

The size of the average primary particle diameter of the fine inorganic particles, the fine inorganic oxide particles, and the fine resin particles is preferably from 5 nm to 2 μm. The content of the other fine particles in the toner depends on the type of the particles, but is preferably in the range of 0.01 mass % to 5 mass % of the toner particles.

The surface of the other fine particles is preferably hydrophobized, and fine inorganic oxide particles such as silica having been hydrophobized are preferably used.

Examples of the fine inorganic particles include, but are not limited to, silica, alumina, barium titanate, magnesium titanate, calcium titanate, strontium titanate, zinc oxide, tin oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide, and silicon nitride. These fine inorganic particles can be used alone or in combination of two or more types.

Examples of the fine resin particles include, but are not limited to, fine particles of polystyrene obtained by soap-free emulsion polymerization, suspension polymerization, and dispersion polymerization, fine particles of polycondensation resins such as methacrylic acid ester and acrylic ester copolymers, silicone, benzoguanamine, and nylon, and polymer particles formed of a thermosetting resin.

A hydrophobizing agent used in the hydrophobizing treatment is not particularly limited and can be appropriately selected according to a purpose. Examples thereof include, but are not limited to, dimethyldichlorosilane, trimethylchlorosilane, methyltrichlorosilane, allyldimethyldichlorosilane, allylphenyldichlorosilane, benzyldimethylchlorosilane, bromomethyldimethylchlorosilane, α-chloroethyltrichlorosilane, p-chloroethyltrichlorosilane, chloromethyldimethylchlorosilane, chlormethyltrichlorosilane, p-chlorophenyltrichlorosilane, 3-chloropropyltrichlorosilane, 3-chloropropyltrimethoxysilane, vinyltriethoxysilane, vinylmethoxysilane, vinyl-tris(β-methoxyethoxy) silane, γ-methacryloxypropyltrimethoxysilane, vinyltriacetoxysilane, divinyldichlorosilane, dimethylvinylchlorosilane, octyl-trichlorosilane, decyl-trichlorosilane, nonyl-trichlorosilane, (4-t-propylphenyl)-trichlorosilane, (4-t-butylphenyl)-trichlorosilane, dipentyl-dichlorosilane, dihexyl-dichlorosilane, dioctyl-dichlorosilane, dinonyl-dichlorosilane, didecyl-dichlorosilane, didodecyl-dichlorosilane, dihexadecyl-dichlorosilane, (4-t-butylphenyl)-octyl-dichlorosilane, dioctyl-dichlorosilane, didecenyl-dichlorosilane, dinonenyl-dichlorosilane, di-2-ethylhexyl-dichlorosilane, di-3,3-dimethylpentyl-dichlorosilane, trihexyl-chlorosilane, trioctyl-chlorosilane, tridecyl-chlorosilane, dioctyl-methyl-chlorosilane, octyl-dimethyl-chlorosilane, (4-t-propylphenyl)-diethyl-chlorosilane, octyltrimethoxysilane, hexamethyldisilazane, hexaethyldisilazane, diethyltetramethyldisilazane, hexaphenyldisilazane, and hexatolyldisilazane.

In addition, titanate coupling agents and aluminum coupling agents can also be used.

A general powder mixer can be used to mix the above-mentioned external additive and toner base particles. However, a mixer equipped with a jacket or the like by which the internal temperature can be controlled is preferable. Examples of preferable mixers include, but are not limited to, a V-type mixer, a rocking mixer, a Loedige mixer, a NAUTA mixer, and a Henschel mixer.

The fine inorganic particles, the fine inorganic oxide particles, and the fine resin particles may be contained in (added to the inside of) the toner.

When the fine inorganic particles, the fine inorganic oxide particles, and the fine resin particles are added to the inside of the toner, the transferability and the durability are improved, and also the pulverization properties of the toner are improved. Further, by adding fine particles to both the outside of the toner and the inside of the toner, the fine inorganic particles and the fine resin particles added to the outside of the toner are prevented from being embedded to the inside of the toner, and thus, excellent transferability is stably obtained and the durability is also improved.

### <Amorphous Polyester Resin>

The amorphous polyester resin contained in the toner of the present embodiment is not particularly limited and a known amorphous polyester resin can be used. However, the amorphous polyester resin preferably contains at least bisphenol A and ethylene glycol as diol components. When the amorphous polyester resin contains bisphenol A as a diol component, the toner is provided with good heat resistance. Further, when the amorphous polyester resin contains ethylene glycol as a diol component, good dispersibility with wax having a low solubility parameter (SP) value can be maintained. As a result, the durability of the toner can be improved.

In addition to bisphenol A and ethylene glycol, a dihydric alcohol may be used as a monomer unit included in the amorphous polyester resin.

Examples of the dihydric alcohol include, but are not limited to, propylene glycol, 1,3-butanediol, 1,4-butanediol, 2,3-butanediol, diethylene glycol, triethylene glycol, 1,5-pentanediol, 1,6-hexanediol, neopentyl glycol, 2-ethyl-1,3-hexanediol, hydrogenated bisphenol A, or diols obtained by polymerization of bisphenol A with a cyclic ether such as ethylene oxide or propylene oxide.

Further, for crosslinking the amorphous polyester resin, a trihydric or higher polyhydric alcohol may be used in combination.

Examples of the trihydric or higher polyhydric alcohol include, but are not limited to, sorbitol, 1,2,3,6-hexanetetrol, 1,4-sorbitan, pentaerythritol, for example, dipentaerythritol and tripentaerythritol, 1,2,4-butanetriol, 1,2,5-pentatriol, glycerol, 2-methylpropanetriol, 2-methyl-1,2,4-butanetriol, trimethylolethane, trimethylolpropane, and 1,3,5-trihydroxybenzene.

Examples of the acid component forming the amorphous polyester resin include, but are not limited to, benzene dicarboxylic acids such as phthalic acid, isophthalic acid, and terephthalic acid, and anhydrides of these benzene dicarboxylic acids, alkyl dicarboxylic acids such as succinic acid, adipic acid, sebacic acid, azelaic acid, and anhydrides of these alkyl dicarboxylic acids, unsaturated dibasic acids such as maleic acid, citraconic acid, itaconic acid, alkenylsuccinic acid, fumaric acid, and mesaconic acid, and unsaturated dibasic acid anhydrides such as maleic anhydride, citraconic anhydride, itaconic anhydride, and alkenylsuccinic anhydrides.

Further, trivalent or higher polyvalent carboxylic acids can also be used as the acid component forming the amorphous polyester resin. Examples of the trivalent or higher polyvalent carboxylic acids include, but are not limited to, trimellitic acid, pyromellitic acid, 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxy-2-methyl-2-methylenecarboxypropane, tetra(methylenecarboxy) methane, 1,2,7,8-octanetetracarboxylic acid, and EMPOL trimer acid, and anhydrides and partial lower alkyl esters of these carboxylic acids.

The acid value of the amorphous polyester resin is preferably from 0.1 mg KOH/g to 100 mg KOH/g, more preferably from 0.1 mg KOH/g to 70 mg KOH/g, and even more preferably from 0.1 mg KOH/g to 50 mg KOH/g. In the present disclosure, the molecular weight distribution of the amorphous polyester resin can be measured by gel permeation chromatography (GPC) using THE as a solvent.

### <Crystalline Polyester Resin>

The toner of the present embodiment preferably further contains a crystalline polyester resin. When the toner contains a crystalline polyester resin, better low-temperature fixability can be obtained.

The crystalline polyester resin preferably has a melting point of 100° C. to 120° C. When the melting point of the crystalline polyester resin is 100° C. or higher, the glass transition temperature of a non-crystallized portion partially present in the crystalline polyester resin becomes higher in accordance with the melting point. The glass transition temperature of that portion and the glass transition temperature of the amorphous polyester resin thus become similar, and the compatibility increases to increase low-temperature fixability.

When the melting point of the crystalline polyester resin is 120° C. or lower, the resin melts sufficiently by heat during fixing, and thus, it is easy to ensure the low-temperature fixability.

The crystalline polyester resin can be manufactured by a general method to perform a polycondensation reaction between (I) a polyvalent carboxylic acid including a linear unsaturated aliphatic divalent carboxylic acid or a reactive derivative thereof (such as an acid anhydride, a lower alkyl ester having 1 to 4 carbon atoms, and an acid halide), and (II) a polyhydric alcohol including a linear aliphatic diol.

A small amount of other polyvalent carboxylic acids can be added to the polyvalent carboxylic acid described in (I), if desired.

Examples of the other polyvalent carboxylic acids include (i) unsaturated aliphatic dicarboxylic acids having branched chains; (ii) saturated aliphatic polyvalent carboxylic acids such as saturated aliphatic dicarboxylic acids and saturated aliphatic tricarboxylic acids; and (iii) aromatic polyvalent carboxylic acids such as aromatic dicarboxylic acids and aromatic tricarboxylic acids.

The added amount of the other polycarboxylic acids described in (i) to (iii) is usually 30 mol % or less, and preferably 10 mol % or less, with respect to the amount of the polyvalent carboxylic acid described in (I). The added amount can be appropriately adjusted so long as the obtained polyester resin has crystallinity.

Specific examples of the other polyvalent carboxylic acids include, but are not limited to, dicarboxylic acids such as malonic acid, succinic acid, glutaric acid, adipic acid, suberic acid, sebacic acid, citraconic acid, phthalic acid, isophthalic acid, and terephthalic acid; and tricarboxylic acids or polyvalent carboxylic acids of higher valence such as trimellitic anhydride, 1,2,4-benzenetricarboxylic acid, 1,2,5-benzenetricarboxylic acid, 1,2,4-cyclohexanetricarboxylic acid, 1,2,4-naphthalenetricarboxylic acid, 1,2,5-hexanetricarboxylic acid, 1,3-dicarboxyl-2-methylenecarboxypropane, and 1,2,7,8-octanetetracarboxylic acid.

If desired, a small amount of other polyhydric alcohols can be added to the polyhydric alcohol described in (II) above. Examples of the other polyhydric alcohols include aliphatic branched chain dihydric alcohols and cyclic dihydric alcohols, and trihydric alcohols or higher polyhydric alcohols.

The added amount of the other polyhydric alcohol is 30 mol % or less, and preferably 10 mol % or less, with respect to the amount of the polyhydric alcohol described in (II) above, and the added amount can be appropriately adjusted so long as the obtained polyester has crystallinity.

Examples of the other polyhydric alcohols include, but are not limited to, 1,4-bis(hydroxymethyl)cyclohexane, polyethylene glycol, bisphenol A ethylene oxide adducts, bisphenol A propylene oxide adducts, and glycerin.

The crystalline polyester resin preferably has a molecular weight distribution having a sharp peak and a relatively low molecular weight from the viewpoint of low-temperature fixability. The molecular weight distribution of the crystalline polyester resin that is determined by gel permeation chromatography (GPC) of o-dichlorobenzene-soluble matter preferably has the following features: the weight average molecular weight (Mw) is from 5500 to 6500, the number average molecular weight (Mn) is from 1300 to 1500, and the ratio Mw/Mn is from 2 to 5.

The molecular weight distribution of the crystalline polyester resin is based on a molecular weight distribution diagram in which the horizontal axis represents log M (M being the molecular weight) and the vertical axis represents mass %. In the molecular weight distribution diagram of the crystalline polyester resin of the present embodiment, the maximum value of the molecular weight peak is preferably in the range of 3.5 mass % to 4.0 mass %, and the half width of the peak is preferably 1.5 or less.

The content of the crystalline polyester resin in the toner base particles is preferably 5.0 mass % or less. When the content of the crystalline polyester resin in the toner base particles is 5.0 mass % or less, the resulting toner is prevented from recrystallizing and adhering to the, and the occurrence of image blur is prevented.

### <Aromatic Petroleum Resin>

The toner of the present embodiment preferably contains an aromatic petroleum resin. When the toner contains an aromatic petroleum resin, pulverization properties of the toner is improved, and heat resistance is improved while low-temperature fixability is maintained.

The aromatic petroleum resin is a resin synthesized by using, as a raw material, styrene, vinyltoluene, indene, and the like, which are C9 fractions of petroleum. In particular, styrene-based copolymers of styrene or α-methylstyrene are preferred.

The weight average molecular weight of the aromatic petroleum resin is preferably 2,000 or more and 3,500 or less. When the weight average molecular weight is 2,000 or more, the durability of the resin in an actual machine can be easily ensured, and when the weight average molecular weight is 3,500 or less, it is easy to ensure good pulverization properties of the toner.

The styrene-based copolymer is not particularly limited. However, examples thereof include, but are not limited to, polymers of styrene and substituted products thereof such as polystyrene, poly-p-styrene, and polyvinyltoluene, and styrene-based copolymers such as styrene-α-methylstyrene copolymer, styrene-p-chlorostyrene copolymer, styrene-propylene copolymer, styrene-vinyltoluene copolymer, styrene-methyl acrylate copolymer, styrene-ethyl acrylate copolymer, styrene-butyl acrylate copolymer, styrene-methyl methacrylate copolymer, styrene-ethyl methacrylate copolymer, styrene-butyl methacrylate copolymer, styrene-α-methyl chloromethacrylate copolymer, styrene-acrylonitrile copolymer, styrene-vinyl methyl ether copolymer, styrene-vinyl methyl ketone copolymer, styrene-butadiene copolymer, styrene-isoprene copolymer, styrene-maleic acid copolymer, and styrene-maleic acid ester copolymer. Among these copolymers, styrene-α-methylstyrene copolymer is particularly preferable.

The glass transition temperature (Tg) of the styrene-based copolymer is preferably 60° C. or higher, and more preferably from 65° C. to 85° C. When the Tg of the styrene resin is 60° C. or higher, the heat-resistant storage stability can be improved.

The Tg can be measured by using a differential scanning calorimeter (Q-200, manufactured by TA Instruments).

For example, in a specific measurement method, a sample container made of aluminum is filled with about 5.0 mg of a target sample. Subsequently, the sample container is placed on a holder unit, set in an electric furnace, and heated at a heating rate of 10°/min in a nitrogen atmosphere, to increase the temperature from −80° C. to 150° C. and obtain a DSC curve. An analysis program in the differential scanning calorimeter is used to determine the glass transition temperature (Tg) of the target sample from the obtained DSC curve.

When the toner of the present embodiment contains an aromatic petroleum resin and the crystalline polyester, the mass ratio of the crystalline polyester with respect to the aromatic petroleum resin is preferably 1.0 or more and 1.2 or less.

The aromatic petroleum resin is dispersed in the toner to improve the pulverization properties of the toner. However, the aromatic petroleum resin has a glass transition temperature at a certain level or higher, and thus may impede the low-temperature fixability. The crystalline polyester resin improves the low-temperature fixability. However, the crystalline polyester resin may impede the pulverization properties of the toner due to the presence of crystallized portions. Further, in general, the crystalline polyester resin tends to be partially compatible with an amorphous polyester resin, and thus, the ratio of the crystallized portions in the toner may be slightly smaller than the amount added to the toner.

Therefore, when the toner of the present embodiment contains the aromatic petroleum resin and the crystalline polyester resin, to properly achieve the effects of each of the materials, the mass ratio of the two materials in the toner is preferably at a similar level.

When the mass ratio of the crystalline polyester resin with respect to the aromatic petroleum resin is within the range mentioned above, the effects of both materials, which have opposite effects on the pulverization properties and the low-temperature fixability of the toner, are appropriately achieved, and both high pulverization properties and a high low-temperature fixability of the toner are achieved.

The content of the aromatic petroleum resin in the toner base particles is preferably 3.0 mass % or more. When the content of the aromatic petroleum resin in the toner base particles is 3.0 mass % or more, better dispersibility of the wax is obtained and the durability is improved, while the pulverization properties of the toner is maintained at a certain level or higher.

### <Wax>

The wax contained in the toner of the present embodiment is not particularly limited and can be appropriately selected from known waxes.

Examples of waxes include, but are not limited to, natural waxes including plant-based waxes such as carnauba wax, cotton wax, wood wax, and rice wax; animal-based waxes such as beeswax and lanolin; mineral-based waxes such as ozokerite and ceresin; and petroleum waxes such as paraffin, microcrystalline wax, and petrolatum.

In addition to these natural waxes, examples of waxes include, but are not limited to, synthetic waxes including synthetic hydrocarbon waxes such as Fischer-Tropsch wax, polyethylene, and polypropylene; esters, ketones, and ethers.

Further, fatty acid amide compounds such as 12-hydroxystearamide, stearamide, phthalimide anhydride, and chlorinated hydrocarbons; polyacrylate homopolymers or copolymers such as poly-n-stearyl methacrylate and poly-n-lauryl methacrylate, which are crystalline polymer resins having low molecular weight (for example, n-stearyl acrylate-ethyl methacrylate copolymer); and crystalline polymers having long alkyl groups in a side chain may also be used as the wax.

Among these waxes, hydrocarbon waxes such as paraffin wax, microcrystalline wax, Fischer-Tropsch wax, polyethylene wax, and polypropylene wax are preferred.

The melting point of the wax is not particularly limited and can be appropriately selected according to a purpose. However, the melting point is preferably 60° C. or higher and lower than 95° C.

When the melting point of the wax is 60° C. or higher, the wax as a release agent hardly melts at low temperatures, thereby maintaining the heat-resistant storage stability of the toner. When the melting point of the wax is lower than 95° C., the wax as a release agent can be sufficiently melted by heating during fixing, and sufficient offset properties can be obtained.

Preferably, the wax is a hydrocarbon wax.

The hydrocarbon wax is almost not compatible with the amorphous polyester resin and the crystalline polyester resin and thus, these materials can function independently of each other. Therefore, the hydrocarbon wax does not impair the softening effect of the crystalline polyester resin as a binder resin and the offset properties of the wax as a release agent, which is preferred.

The wax is more preferably a hydrocarbon wax having a melting point of 60° C. or higher and lower than 95° C.

A hydrocarbon wax having a melting point of 60° C. or higher and lower than 95° C. can effectively act as a release agent at an interface between a fixing roller and a toner, and thus, the high temperature offset resistance is improved without applying a release agent such as oil to the fixing roller.

The content of the wax in the toner is not particularly limited and can be appropriately selected according to a purpose. However, the content of the wax in the toner is preferably from 2 mass % to 10 mass %, and more preferably from 3 mass % to 8 mass %.

When the content of the wax in the toner is 2 mass % or more, the high-temperature offset resistance and the low-temperature fixability are exhibited during fixing. When the content of the wax is 10 mass % or less, the heat-resistant storage stability can be maintained and image fogging and the like is less likely to occur. When the content of the wax is within the range mentioned above, the image quality and the fixing stability are further improved.

### <Colorant>

The toner of the present embodiment preferably contains a colorant.

As the colorant used in the toner of the present embodiment, any known dyes and pigments can be used.

Examples of the colorant include, but are not limited to, carbon black, nigrosine dye, iron black, Naphthol Yellow S, Hansa Yellow (10G, 5G, G), Cadmium Yellow, yellow iron oxide, ocher, chrome yellow, titanium yellow, Polyazo Yellow, Oil Yellow, Hansa Yellow (GR, A, RN, R), Pigment Yellow L, Benzidine Yellow (G, GR), Permanent Yellow (NCG), Vulcan Fast Yellow (5G, R), Tartrazine Lake, Quinoline Yellow Lake, Anthrazan Yellow BGL, Isoindolinone Yellow, Bengara, red lead, lead vermilion, Cadmium Red, Cadmium-Mercury Red, antimony vermilion, Permanent Red 4R, Para Red, Fire Red, Para-chloro-ortho-nitro Aniline Red, Lithol Fast Scarlet G, Brilliant Fast Scarlet, Brilliant Carmine BS, Permanent Red (F2R, F4R, FRL, FRLL, F4RH), Fast Scarlet VD, Vulcan Fast Rubin B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, Bon Maroon Light, Bon Maroon Medium, Eosin Lake, Rhodamine Lake B, Rhodamine Lake Y, Alizarin Lake, Thioindigo Red B, Thioindigo Maroon, Oil Red, Quinacridone Red, Pyrazolone Red, Polyazo Red, Chrome Vermilion, Benzidine Orange, Perinone Orange, Oil Orange, Cobalt Blue, Cerulean Blue, Alkali Blue Lake, Peacock Blue Lake, Victoria Blue Lake, metal-free Phthalocyanine Blue, Phthalocyanine Blue, Fast Sky Blue, Indanthrene Blue (RS, BC), indigo, ultramarine blue, Prussian blue, Anthraquinone Blue, Fast Violet B, Methyl Violet Lake, cobalt violet, manganese violet, Dioxane Violet, Anthraquinone Violet, Chrome Green, Zinc Green, chromium oxide, viridian, Emerald Green, Pigment Green B, Naphthol Green B, Green Gold, Acid Green Lake, Malachite Green Lake, Phthalocyanine Green, Anthraquinone Green, titanium oxide, zinc white, and lithopone, and mixtures of these colorants.

The content of the colorant in the toner is preferably from 1 mass % to 15 mass %, and more preferably from 3 mass % to 10 mass %.

A masterbatch obtained by mixing the colorant with a resin may be used to manufacture the toner. The same resins as those mentioned above can be used as the resin to be kneaded with the colorant for preparing the masterbatch. The resin to be kneaded with the colorant may be used alone or in combination of two or more types of resins.

The masterbatch can be obtained by mixing and kneading a resin for preparing a masterbatch and a colorant under high shear force. At this time, an organic solvent can be used to enhance the interaction between the colorant and the resin. Alternatively, a method called a flushing method can be used, in which an aqueous paste of a water-containing colorant is mixed and kneaded with a resin and an organic solvent, the colorant is transferred to the side of the resin, and the water component and the organic solvent component are removed. According to the flushing method, the wet cake of the colorant can be used unchanged and thus, does not need to be dried, so that the wet cake can be used conveniently. To perform the mixing and kneading in the flushing method, a high shear dispersion device such as a three-roll mill is suitably used.

The amount of the masterbatch being used is preferably from 0.1 to 20 parts by mass with respect to 100 parts by mass of the resin.

When preparing the masterbatch, it is preferable to disperse the colorant in the resin. The resin for preparing a masterbatch preferably has an acid value of 30 mg KOH/g or less and an amine value of 1 to 100, and more preferably an acid value of 20 mg KOH/g or less and an amine value from 10 to 50. When the acid value of the resin for preparing a masterbatch is 30 mg KOH/g or less, the charging properties do not decrease even under high humidity and the dispersibility of the colorant is also sufficient. When the amine value is from 1 to 100, the colorant has sufficient dispersibility.

The acid value of the resin for preparing a masterbatch can be measured by the method described in JIS K0070. The amine value can be measured by the method described in JIS K7237.

Further, a dispersant can be used to improve the dispersibility of the colorant. The dispersant preferably has high compatibility with the resin, from the viewpoint of dispersibility of the colorant.

Examples of the dispersant include, but are not limited to, commercially available products such as “AJISPER PB821” and “AJISPER PB822” (manufactured by Ajinomoto Fine-Techno Co., Inc.), “DISPERBYK-2001” (manufactured by BYK Chemie Co., Ltd.), and “EFKA-4010” (manufactured by EFKA Co., Ltd.).

From the viewpoint of the dispersibility of the colorant, the mass average molecular weight of the dispersant is preferably from 500 to 100,000, more preferably from 3,000 to 100,000, even more preferably from 5,000 to 50,000, and particularly preferably from 5,000 to 30,000 expressed as the molecular weight of the maximum value of the main peak in styrene equivalent mass measured by gel permeation chromatography.

If the molecular weight of the dispersant is 500 or more, the polarity is not too high and the dispersibility of the colorant does not easily deteriorate. If the molecular weight of the dispersant is 100,000 or less, the affinity with the solvent is not too high and the dispersibility of the colorant is unlikely to decrease.

The dispersant is preferably blended into the toner at a ratio of 0.1 to 10 mass % with respect to the colorant. When the blending ratio of the dispersant is 0.1 mass % or more of the colorant, the dispersibility of the colorant is sufficient. When the blending ratio of the dispersant is 10 mass % or less, the charging properties are unlikely to deteriorate under high humidity.

### <Charge Control Agent>

The toner of the present embodiment may contain a charge control agent, if desired. Any known charge control agent can be used. However, in color toners, white or light-colored charge control agents are preferred. When using a colored charge control agent, the content thereof is preferably small to prevent the color from mixing with the toner and dulling the toner.

Examples of the charge control agent include, but are not limited to, nigrosin-based dyes, triphenylmethane-based dyes, chromium-containing metal complex dyes, molybdate chelate pigments, rhodamine-based dyes, alkoxy-based amines, quaternary ammonium salts (including fluorine-modified quaternary ammonium salts), alkylamides, elemental phosphorus or phosphorus compounds, elemental tungsten or tungsten compounds, fluorine-based activators, metal salts of salicylic acid, and metal salts of salicylic acid derivatives. Specific examples of the charge control agent include, but are not limited to, the nigrosin-based dye BONTRON 03, the quaternary ammonium salt BONTRON P-51, the metal-containing azo dye BONTRON S-34, the oxynaphthoic acid-based metal complex E-82, the salicylic acid-based metal complex E-84, the phenolic condensate E-89 (all manufactured by Orient Chemical Industries Co., Ltd.), the quaternary ammonium salt molybdenum complexes TP-302 and TP-415 (both manufactured by Hodogaya Chemical Co., Ltd.), the quaternary ammonium salt copy charge PSY VP2038, the triphenylmethane derivative copy blue PR, the quaternary ammonium salt copy charge NEG VP2036, and the copy charge NX VP434 (all manufactured by Hoechst AG), LRA-901 and the boron complex LR-147 (manufactured by Japan Carlit Co., Ltd.), copper phthalocyanine, perylene, quinacridone, azo pigments, and in addition, polymeric compounds having functional groups such as sulfonic acid groups, carboxyl groups, and quaternary ammonium salts.

The charge control agent can be melt-kneaded together with a resin, a mold release agent, and a masterbatch.

The amount of the charge control agent being used is preferably from 0.1 to 10 parts by mass, and more preferably from 0.2 to 5 parts by mass, with respect to 100 parts by mass of the resin. If the amount of the charge control agent being used is within the range mentioned above, the chargeability of the toner is not too large. Therefore, the effect of the charge control agent is not diminished, the electrostatic attraction force with a developing roller is maintained at an appropriate level, and the fluidity of the developer and the image density are less likely to decrease.

The amount of the charge control agent being used can be appropriately adjusted depending on the type of the resin used in the toner, the presence of additives, which are used as desired, and the toner manufacturing method including the dispersion method.

### <Other Components>

Further, the toner may contain other components as appropriate according to a purpose.

Examples of the other components include, but are not limited to, fluidity improvers, cleanability improvers, magnetic materials, and metal soaps.

The fluidity improvers refer to agents that perform a surface treatment of components that can be contained in the toner to increase the hydrophobicity of the toner, so the deterioration of fluidity characteristics and charging characteristics is prevented even under high humidity.

Examples of the fluidity improver include, but are not limited to, silane coupling agents, silylating agents, silane coupling agents having a fluorinated alkyl group, organic titanate coupling agents, aluminum-based coupling agents, silicone oil, and modified silicone oil.

The cleanability improver is used to remove developer remaining on the electrostatic latent image bearer or the intermediate transfer body after transfer.

Examples of the cleanability improver include, but are not limited to, fatty acid metal salts such as zinc stearate, calcium stearate, and stearic acid, and polymer fine particles prepared by soap-free emulsion polymerization such as polymethyl methacrylate fine particles, and polystyrene fine particles. The polymer fine particles preferably have a relatively narrow peak width in the particle size distribution, and preferably have a mass average particle diameter of 0.01 to 1 μm.

The magnetic material is not particularly limited and can be appropriately selected from known materials according to a purpose. Examples of the magnetic material include, but are not limited to, iron powder, magnetite, and ferrite. Among these, magnetic materials having a color tone that does not easily mix with the toner are preferred, magnetic materials of light color are more preferred, and magnetic materials of white color are even more preferred.

### (Method of Manufacturing Toner)

A method of manufacturing the toner in the present embodiment is not particularly limited. Examples of the method include, but are not limited to, a melt-kneading and pulverization method, a polymerization method, a polyaddition reaction method using a prepolymer containing an isocyanate group, a method of dissolving in a solvent, removing the solvent, and pulverizing to manufacture the toner, and in addition, a melt spray method.

For example, it is also possible to adopt a melt-kneading method, a polymerization method in which a monomer composition containing a specific crystalline polymer and a polymerizable monomer is directly polymerized in an aqueous phase (suspension polymerization method/emulsion polymerization method), a polyaddition reaction method in which a composition containing a specific crystalline polymer and a prepolymer containing an isocyanate group is directly extended/crosslinked with amines in an aqueous phase, and a method of dissolving in a solvent, removing the solvent, and pulverizing.

Note that in the toner of the present embodiment, the main component of the resin is preferably a polyester resin.

In the melt-kneading and pulverization method, devices such as a batch-type two-roll machine, a Banbury mixer, a continuous-type twin-screw extruder, a KTK-type twin-screw extruder manufactured by Kobe Steel, Ltd., a TEM-type twin-screw extruder manufactured by Toshiba Machine Co., Ltd., a twin-screw extruder manufactured by KCK Company, a PCM-type twin-screw extruder manufactured by Ikegai Iron Works Co., Ltd., a KEX-type twin-screw extruder and a continuous-type single-screw kneader manufactured by Kurimoto Ltd., and a co-kneader manufactured by Buss AG may be appropriately used to melt-knead the toner.

In the above-mentioned polymerization method and polyaddition reaction method using a prepolymer containing an isocyanate group, it is desired to apply mechanical energy in the aqueous phase to forcibly perform an emulsification process (formation of droplets). Examples of units for applying such mechanical energy include, but are not limited to, application units used for applying strong stirring or ultrasonic vibration energy, such as a homomixer, ultrasonic waves, or a Manton-Gaulin homogenizer.

In the pulverization of a toner raw material, a hammer mill, a Rotoplex, or the like may be used to coarsely pulverize the raw material, and then, a fine pulverizer using a jet stream or a mechanical fine pulverizer may be used to pulverize the raw material to an appropriate size. It is preferable to grind the raw material so that the mass average particle diameter is from 3 to 15 μm. Further, it is preferable that the pulverized product is adjusted to have a mass average particle diameter of 5 to 20 μm by using an aerodynamic classifier or the like.

The softening temperature of the toner (T_{1/2}: temperature at which half of the sample flows out under increased temperature and a predetermined load) determined by a flow tester is preferably from 115 to 140° C. From the viewpoint of the storage stability of the toner, the glass transition temperature (Tg) of the toner is preferably from 55 to 70° C., and more preferably from 57 to 70° C. If the Tg of the toner is 55° C. or higher, the toner is less likely to deteriorate in a high-temperature atmosphere, and offset is less likely to occur during fixing. Further, if the Tg of the toner is 70° C. or lower, the fixability of the toner is unlikely to deteriorate.

In a method of coating the toner base particles with the external additive, the toner base particles and the external additive may be mixed and stirred by using a mixer, to crush the external additive and coat the surface of the toner base particles with the external additive. At this time, by causing the external additive to uniformly and firmly adhere to the toner base particles, the durability of the toner can be improved.

### (Developer)

The developer using the toner of the present embodiment may be any one among a one-component developer and a two-component developer. The two-component developer includes the toner of the present embodiment and a carrier.

The carrier is not particularly limited and can be appropriately selected according to a purpose. However, the carrier preferably includes a core material and a resin layer covering the core material.

The material of the core material is not particularly limited and can be appropriately selected according to a purpose. Preferred examples of the material include, but are not limited to, manganese-strontium (Mn—Sr)-based materials and manganese-magnesium (Mn—Mg)-based materials of 50 emu/g or more and 90 emu/g or less, and further, highly magnetized materials such as iron powder (100 emu/g or more), magnetite (75 emu/g or more and 120 emu/g or less) to ensure image density. Further preferred examples of material of the core material include, but are not limited to, weakly magnetized materials such as copper-zinc (Cu—Zn)-based materials (30 emu/g or more and 80 emu/g or less), which can weaken the contact between the toner and the photoconductor when the toner is in a standing state and thus, are advantageous for high image quality. These materials may be used alone or in combination of two or more types.

The volume average particle diameter of the core material is preferably 25 μm or more and 200 μm or less.

The material of the resin layer is not particularly limited and can be appropriately selected according to a purpose. Examples of the material of the resin layer include, but are not limited to, amino resins, polyvinyl resin, polystyrene resin, halogenated olefin resins, polyester resin, polycarbonate resin, polyethylene resin, polyvinyl fluoride resin, polyvinylidene fluoride resin, polytrifluoroethylene resin, polyhexafluoropropylene resin, copolymers of vinylidene fluoride and an acrylic monomer, copolymers of vinylidene fluoride and vinyl fluoride, fluoro terpolymers such as terpolymers of tetrafluoroethylene, vinylidene fluoride, and a non-fluorinated monomer, and silicone resins. These materials may be used alone or in combination of two or more types.

In the mixing ratio of the toner and the carrier in the two-component developer, the ratio of the toner in the two-component developer is preferably 2.0 mass % or more and 12.0 mass % or less, and more preferably 2.5 mass % or more and 10.0 mass % or less.

### (Toner Storage Unit)

The term toner storage unit as used herein refers to a unit having a function of storing toner and storing toner. Here, specific examples of the toner storage unit include, but are not limited to, a toner storage container, a developing unit, a developing device, and a process cartridge.

The term toner storage container refers to a container storing toner.

The developing unit and the developing device refer to a unit or device used for storing and developing the toner.

The term process cartridge refers to a cartridge in which at least an image bearer and a developing unit are integrally formed, that stores toner, and is attachable to and detachable from an image forming apparatus. The process cartridge may further include one or more unit among a charging unit, an exposure unit, and a cleaning unit.

The toner storage unit of the present embodiment stores the toner of the present embodiment.

By attaching the toner storage unit of the present embodiment to an image forming apparatus and forming an image, an image is formed by using the toner of the present embodiment. Therefore, excellent low-temperature fixability and heat-resistant storage stability, and an excellent image having few abnormalities are obtained.

### (Process Cartridge)

A process cartridge according to one embodiment of the present embodiment includes at least an electrostatic latent image bearer that bears an electrostatic latent image, and a developing unit. The developing unit can use the toner of the present embodiment to form a toner image by developing the electrostatic latent image that is supported on the electrostatic latent image bearer.

The process cartridge may further include other unit, if desired. Examples of the other unit include, but are not limited to, a charging unit, an exposure unit, a transfer unit, a cleaning unit, and a static elimination unit.

The developing unit includes at least a developer container that stores the toner or the developer of the present embodiment, and a developer bearer that supports and conveys the toner or the developer stored in the developer container.

The developing unit may further include a layer thickness regulating member for regulating the thickness of the toner layer supported on the developer carrier.

The process cartridge of the present embodiment is preferably attachable to and detachable from a main body of an image forming apparatus such as various types of electrophotographic apparatuses, facsimile devices, and printers.

### (Image Forming Method and Image Forming Apparatus)

The image forming apparatus of the present embodiment includes an electrostatic latent image bearer, an electrostatic latent image forming unit that forms an electrostatic latent image on the electrostatic latent image bearer, a developing unit that develops the electrostatic latent image by using the toner of the present embodiment to form a toner image, a transfer unit that transfers the toner image to a recording medium, and a fixing unit that fixes the toner image transferred to the recording medium.

The image forming apparatus of the present embodiment may further include other unit such as a static elimination unit, a cleaning unit, a recycling unit, and a control unit, if desired.

An image forming method according to the present embodiment includes an electrostatic latent image forming step of forming an electrostatic latent image on the electrostatic latent image bearer, a developing step of developing, by using the toner of the present embodiment, the electrostatic latent image to form a toner image, a transfer step of transferring the toner image to a recording medium, and a fixing step of fixing the toner image transferred to the recording medium.

The image forming method according to the present embodiment may further include other steps such as a static elimination step, a cleaning step, a recycling step, and a control step, if desired.

### <Electrostatic Latent Image Forming Step and Electrostatic Latent Image Forming Unit>

The electrostatic latent image forming step is a step of forming an electrostatic latent image on the electrostatic latent image bearer.

The electrostatic latent image forming unit is a unit used for forming an electrostatic latent image on the electrostatic latent image bearer.

The electrostatic latent image forming step is suitably performed by the electrostatic latent image forming unit.

The material, shape, structure, and size of the electrostatic latent image bearer (may be referred to as “electrophotographic photoconductor” or “photoconductor” hereinafter) are not particularly limited, and the electrostatic latent image bearer may be appropriately selected from known electrostatic latent image bearers.

Preferred examples of the shape of the electrostatic latent image bearer include, but are not limited to, a drum shape.

Examples of the material of the electrostatic latent image bearer include, but are not limited to, inorganic photoconductors such as amorphous silicon and selenium, and organic photoconductors (OPC) such as polysilane and phthalopolymethine. Among these materials, the organic photoconductors (OPC) are preferred, because images of higher definition can be obtained.

Examples of the organic photoconductor include, but are not limited to, a laminated photoconductor and a single-layer photoconductor. The laminated photoconductor has a laminated structure in which, on a support body such as an aluminum drum, a layer in which a charge generation material such as metal-free phthalocyanine or titanyl phthalocyanine is dispersed in a binder resin (charge generation layer), and a layer in which a charge transport material is dispersed in a binder resin (charge transport layer) are stacked. The single-layer photoconductor includes a photosensitive layer having a single layer structure in which both a charge generation material and a charge transport material are dispersed in a binder resin on a support body. In the case of the single-layer photoconductor, a hole transport agent and an electron transport agent may be added to the photosensitive layer as charge transport materials.

Further, an undercoat layer may be provided between the support body and the charge generation layer in the laminated photoconductor or between the support body and the photosensitive layer in the single-layer photoconductor.

In the electrostatic latent image forming step, the electrostatic latent image is formed by, for example, uniformly charging the surface of the electrostatic latent image bearer by the electrostatic latent image forming unit, and then, exposing the surface in the form of an image.

For example, the electrostatic latent image forming unit may at least include a charging unit (charging device) that uniformly charges the surface of the electrostatic latent image bearer, and an exposure unit (exposure device) that exposes the surface of the electrostatic latent image bearer in the form of the image.

The charging can be performed, for example, by using the charging device to apply a voltage to the surface of the electrostatic latent image bearer.

The charging device is not particularly limited and can be appropriately selected according to a purpose. Examples of the charging device include, but are not limited to, known contact charging devices including a conductive or semiconductive roll, a brush, a film, and a rubber blade, and non-contact charging devices utilizing corona discharge such as a corotron and a scorotron.

The charging device is preferably a charging device that is arranged in contact with or not in contact with the electrostatic latent image bearer and charges the surface of the electrostatic latent image bearer by applying DC and AC voltages in a superimposed manner.

Further, the charging device is preferably a charging device that charges the surface of the electrostatic latent image bearer by applying DC and AC voltages in a superimposed manner to a charging roller. The charging roller is preferably arranged in a non-contact manner close to the electrostatic latent image bearer by using a gap tape.

The exposure can be performed, for example, by using the exposure device to expose the surface of the electrostatic latent image bearer in the form of the image.

The exposure device is not particularly limited and can be appropriately selected according to a purpose, as long as the exposure device can expose, in the form of the image to be formed, the surface of the electrostatic latent image bearer charged by the charging device. Examples of the exposure device include, but are not limited to, copying optical systems, rod lens array systems, laser optical systems, and liquid crystal shutter optical systems.

In the image forming apparatus and the image forming method of the present embodiment, a back-light method may be adopted in which the electrostatic latent image bearer is exposed in the form of an image from the back side.

### <Developing Step and Developing Unit>

The developing step is a step of developing the electrostatic latent image by using the toner of the present embodiment to form a toner image.

The developing unit is a unit that develops the electrostatic latent image by using the toner of the present embodiment to form a toner image.

The developing step is suitably performed by the developing unit.

For example, in the developing step, the toner image can be formed by using the toner to develop the electrostatic latent image, and the developing step can be performed by the developing unit.

For example, the developing unit preferably includes at least a developing unit or a developing device that stores the toner and applies the toner to the electrostatic latent image in a contact or non-contact manner, and more preferably includes a developing unit or a developing device including a toner accommodating container.

The developing unit or the developing device may be for single color applications or for multicolor applications.

A suitable example of the developing unit or the developing device includes, but is not limited to, a device including a stirrer that frictionally stirs the toner to charge the toner and a rotatable magnet roller.

### <Transfer Step and Transfer Unit>

The transfer step is a step of transferring the toner image onto a recording medium.

The transfer unit is a unit that transfers the toner image onto a recording medium.

The transfer step is suitably performed by the transfer unit.

In a preferred aspect of the transfer step, an intermediate transfer body is used to transfer the toner image by primary transfer onto the intermediate transfer body, and then, the toner image is transferred by secondary transfer onto the recording medium.

Further, in a more preferred aspect of the transfer step, the transfer step includes a primary transfer step of using a toner of two or more colors, preferably a full color toner, as the toner, and transferring the toner image onto the intermediate transfer body to form a composite transfer image, and a secondary transfer step of transferring the composite transfer image onto a recording medium.

The transfer unit used in the transfer step (a primary transfer unit in the primary transfer step, and a secondary transfer unit in the secondary transfer step) preferably include at least a transfer device that charges, by peeling electrification, the toner image formed on the electrostatic latent image bearer (photoconductor) toward the recording medium. The number of the transfer unit may be one, or two or more.

Examples of the transfer device include, but are not limited to, a corona transfer device using corona discharge, a transfer belt, a transfer roller, a pressure transfer roller, and an adhesive transfer device.

Note that the recording medium is not particularly limited and can be appropriately selected from known recording media (recording sheets).

### <Fixing Step and Fixing Unit>

The fixing step is a step of fixing the toner image transferred onto the recording medium.

The fixing unit is a unit that fixes the toner image transferred onto the recording medium.

The fixing step is suitably performed by the fixing unit.

The fixing step may be performed each time the fixing unit transfers the developer of each color to the recording medium, or may be performed simultaneously for the developers of each color in a superimposed state.

The fixing unit is not particularly limited and can be appropriately selected according to a purpose. However, known heating and pressing unit are suitable. Examples of the heating and pressing unit include, but are not limited to, a combination of a heating roller and a pressure roller, and a combination of a heating roller, a pressure roller, and an endless belt.

The static elimination step is a step of applying a static elimination bias to the electrostatic latent image bearer to eliminate static electricity, and can be suitably performed by the static elimination unit.

The static elimination unit is not particularly limited, as long as the static elimination unit can apply a static elimination bias to the electrostatic latent image bearer. The static elimination unit can be appropriately selected from known static elimination devices, and preferred examples of the static elimination unit include, but are not limited to, a static elimination lamp.

The cleaning step is a step of removing the toner remaining on the electrostatic latent image bearer, and can be suitably performed by the cleaning unit.

The cleaning unit is not particularly limited, as long as the cleaning unit can remove the toner remaining on the electrostatic latent image bearer. The cleaning unit can be appropriately selected from known cleaners, and preferred examples of the cleaning unit include, but are not limited to, a magnetic brush cleaner, an electrostatic brush cleaner, a magnetic roller cleaner, a blade cleaner, a brush cleaner, and a web cleaner.

The recycling step is a step in which the toner removed in the cleaning step is recycled by the developing unit, and can be suitably performed by the recycling unit. The recycling unit is not particularly limited, and examples thereof include known conveyance unit.

The control step is a step of controlling each of the steps mentioned above, and each of the steps can be suitably performed by the control unit.

The control unit is not particularly limited and can be appropriately selected according to a purpose, as long as the control unit can control the operation of each of the unit described above. Examples of the control unit include, but are not limited to, equipment such as a sequencer and a computer.

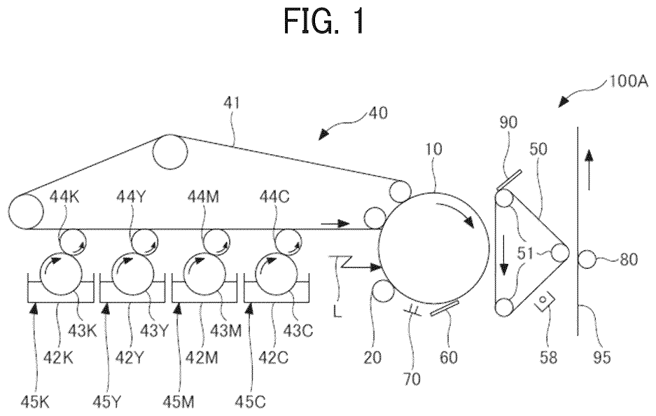

FIG. 1 is a schematic diagram illustrating a part of an image forming apparatus according to one embodiment of the present embodiment.

An image forming apparatus 100A includes a photoconductor drum 10, a charging roller 20, an exposure device, a developing device 40, an intermediate transfer belt 50, a cleaning device 60 including a cleaning blade, and a static elimination lamp 70.

The intermediate transfer belt 50 is an endless belt spanning over three rollers 51 disposed within the loop of the intermediate transfer belt 50, and the intermediate transfer belt 50 can move in the direction of the arrow in FIG. 1. Some of the three rollers 51 also function as transfer bias rollers that can apply a transfer bias (primary transfer bias) to the intermediate transfer belt 50. Further, a cleaning device 90 including a cleaning blade is arranged in the vicinity of the intermediate transfer belt 50. Moreover, a transfer roller 80 that can apply a transfer bias (secondary transfer bias) for transferring the toner image onto a transfer sheet 95, is arranged facing the intermediate transfer belt 50.

Further, a corona charging device 58 for applying an electric charge to the toner image transferred onto the intermediate transfer belt 50 is arranged in the vicinity of the intermediate transfer belt 50 between a contact portion of the photoconductor drum 10 and the intermediate transfer belt 50 and a contact portion of the intermediate transfer belt 50 and the transfer sheet 95, with respect to the rotation direction of the intermediate transfer belt 50.

The developing device 40 includes a developing belt 41 and a black developing unit 45K, a yellow developing unit 45Y, a magenta developing unit 45M, and a cyan developing unit 45C, which store the toner of the present embodiment and are arranged in parallel in the vicinity of the developing belt 41. Note that the developing units 45K, 45Y, 45M, and 45C that store the toner of each color of the present embodiment include developer storage portions 42K, 42Y, 42M, and 42C, developer supply rollers 43K, 43Y, 43M, and 43C, and developing rollers (developing bearers) 44K, 44Y, 44M, and 44C. The developing belt 41 is an endless belt spanning over a plurality of belt rollers, and can move in the direction of the arrow in FIG. 1. Further, a part of the developing belt 41 is in contact with the photoconductor drum 10.

Next, a method of using the image forming apparatus 100A to form an image using the toner of the present embodiment will be described. First, the surface of the photoconductor drum 10 is uniformly charged by using the charging roller 20, and then, an exposure device is used to expose the photoconductor drum 10 to exposure light L to form an electrostatic latent image. Next, the electrostatic latent image formed on the photoconductor drum 10 is developed with toner supplied from the developing device 40 to form a toner image. Further, the toner image formed on the photoconductor drum 10 is transferred (primary transfer) onto the intermediate transfer belt 50 by the transfer bias applied from the rollers 51. Subsequently, the toner image is transferred (secondary transfer) onto the transfer sheet 95 by the transfer bias applied from the transfer roller 80. On the other hand, after the toner image is transferred from the photoconductor drum 10 to the intermediate transfer belt 50, the toner remaining on the surface of the photoconductor drum 10 is removed by the cleaning device 60. Subsequently, the electrostatic charge is removed from the photoconductor drum 10 by the static elimination lamp 70.

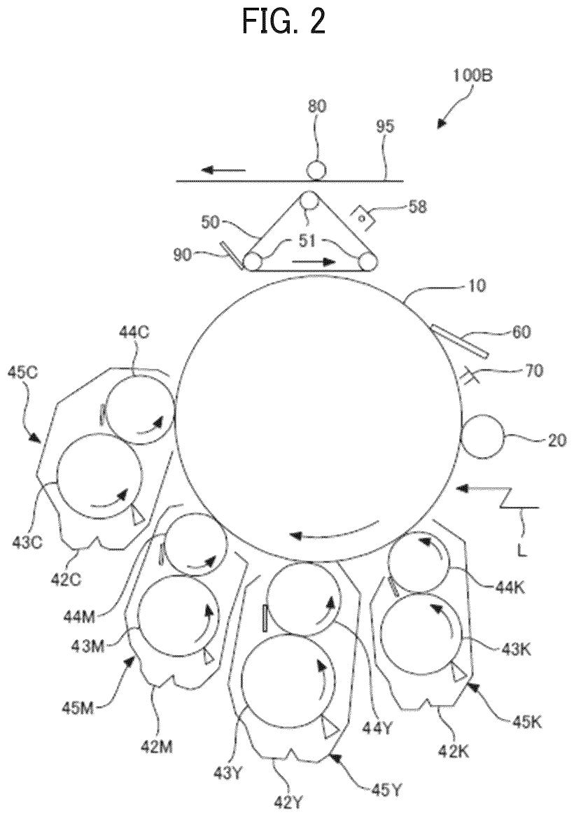

FIG. 2 is a schematic diagram illustrating another image forming apparatus according to one embodiment of the present embodiment. An image forming apparatus 100B has a similar configuration to the image forming apparatus 100A, except that the developing belt 41 is not provided and the black developing unit 45K, the yellow developing unit 45Y, the magenta developing unit 45M, and the cyan developing unit 45C are arranged around the photoconductor drum 10 so as to directly face the photoconductor drum 10.

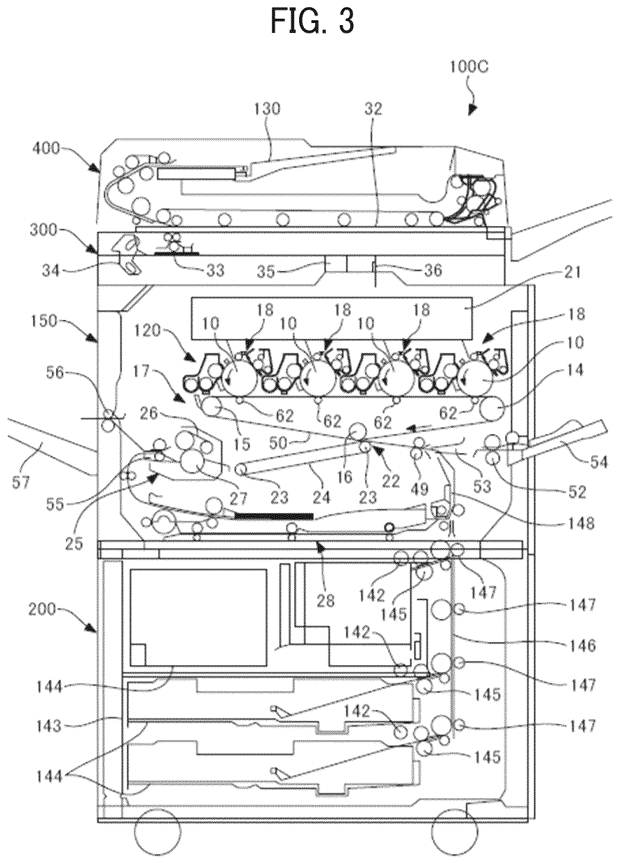

FIG. 3 is a schematic diagram illustrating an image forming apparatus according to one embodiment of the present embodiment. An image forming apparatus 100C is a tandem-type color image forming apparatus, and includes a copier main body 150, a sheet feeding table 200, a scanner 300, and an automatic document feeder (ADF) 400.

The intermediate transfer belt 50 provided in a center portion of the copier main body 150 is an endless belt spanning over three rollers 14, 15, and 16, and can move in the direction of the arrow in FIG. 3. A cleaning device 17 including a cleaning blade for removing toner remaining on the intermediate transfer belt 50 from which the toner image has been transferred to the recording sheet is arranged in the vicinity of the roller 15. Yellow, cyan, magenta, and black image formers 18 (collectively “image forming unit 120) are arranged side by side along a conveyance direction so as to face a part of the intermediate transfer belt 50 spanning over the rollers 14 and 15.

Further, an exposure device 21 is arranged in the vicinity of the image forming unit 120. A secondary transfer belt 24 is arranged on the side of the intermediate transfer belt 50 opposite to the side where the image forming unit 120 is arranged. The secondary transfer belt 24 is an endless belt spanning over a pair of rollers 23, and a recording sheet conveyed on the secondary transfer belt 24 can contact the intermediate transfer belt 50 between the rollers 16 and 23.

Further, in the vicinity of the secondary transfer belt 24, a fixing device 25 is arranged that includes a fixing belt 26, which is an endless belt spanning over a pair of rollers, and a pressure roller 27 arranged to be pressed against the fixing belt 26. When an image is to be formed on both sides of the recording sheet, a sheet reversing device 28 for reversing the recording sheet is arranged in the vicinity of the secondary transfer belt 24 and the fixing device 25.

Next, a method of using the image forming apparatus 100C to form a full-color image by using the toner of the present embodiment will be described. First, a color document is set on a document stand 130 of the automatic document feeder (ADF) 400. Alternatively, the automatic document feeder 400 is opened, the color document is set on a contact glass 32 of the scanner 300, and the automatic document feeder 400 is closed.

When a start switch is pressed, if the document is set on the automatic document feeder 400, the document is conveyed and moved onto the contact glass 32. On the other hand, if the document is set on the contact glass 32, the scanner 300 is immediately driven, and a first traveling body 33 including a light source and a second traveling body 34 including a mirror travel. At this time, light reflected from the document surface of the light emitted from the first traveling body 33 is reflected by the second traveling body 34, and then, the light is received by a reading sensor 36 via an image forming lens 35. Thus, the document is read and black, yellow, magenta, and cyan image information is obtained.

The image information of each color is transmitted to each of the image formers 18 in the image forming unit 120, and a toner image of each color is formed.

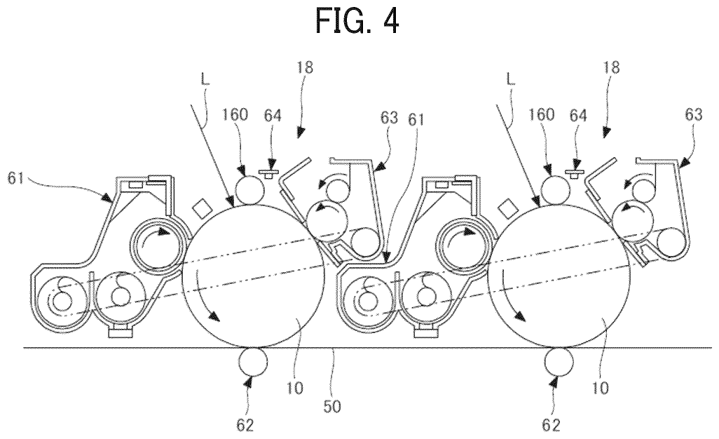

FIG. 4 is a schematic diagram illustrating a part of the image forming apparatus according to one embodiment of the present embodiment. As illustrated in FIG. 4, the image formers 18 illustrated in FIG. 3 each include the photoconductor drum 10, a charging roller 160 that uniformly charges the photoconductor drum 10, a developing device 61 that develops the electrostatic latent image with a developer of each color to form a toner image of each color, a transfer roller 62 that transfers the toner image onto the intermediate transfer belt 50, a cleaning device 63 including a cleaning blade, and a static elimination lamp 64.

The toner images of each color formed by the image formers 18 of each color illustrated in FIG. 3 are sequentially transferred (primary transfer) onto the intermediate transfer belt 50 that moves while spanning over the rollers 14, 15, and 16, and are superimposed to form a composite toner image.

On the other hand, in the sheet feeding table 200, one of sheet feeding rollers 142 is selectively rotated to feed a recording sheet from one of sheet feeding cassettes 144 provided in multiple stages in a paper bank 143, and the recording sheets are separated one by one by a separation roller 145 and transported to a sheet feeding path 146. The recording sheets are conveyed by conveyance rollers 147, guided to a sheet feeding path 148 in the copier main body 150, and stopped by colliding with a registration roller 49. Alternatively, recording sheets on a manual feed tray 54 are fed by rotating a sheet feeding roller, separated one by one by a separation roller 52, guided to a manual sheet feeding path 53, and stopped by colliding with the registration roller 49.

The registration roller 49 is generally used while being grounded, but may be used in a state where a bias is applied to remove paper dust from the recording sheet.

Next, by rotating the registration roller 49 at a timing in synchronization with the composite toner image formed on the intermediate transfer belt 50, the recording sheet is transported between the intermediate transfer belt 50 and the secondary transfer belt 24, and the composite toner image is transferred (secondary transfer) onto the recording sheet. The toner remaining on the intermediate transfer belt 50 to which the composite toner image is transferred is removed by the cleaning device 17.

The recording sheet onto which the composite toner image is transferred is conveyed by the secondary transfer belt 24, and then, the composite toner image is fixed by the fixing device 25. Next, the conveyance path of the recording sheet is switched by a switching claw 55, and the recording sheet is ejected onto a sheet discharge tray 57 by a discharge roller 56. Alternatively, the conveyance path of the recording sheet is switched by the switching claw 55, the recording sheet is reversed by the sheet reversing device 28, and an image is formed in a similar manner on the back side of the recording sheet. Subsequently, the recording sheet is ejected onto the sheet discharge tray 57 by the discharge roller 56.

### EXAMPLES

The present invention will be described in more detail below with reference to examples and comparative examples, but the present invention is not limited to these examples and comparative examples. Note that the term “parts” refers to “parts by mass”, unless otherwise specified.

### (Preparation of Inorganic External Additive 1)

100 g of hydrophilic silica particles (AEROSIL 200: manufactured by Nippon Aerosil Co., Ltd., average primary particle diameter 12 nm) were dispersed in 2 L of water and the mixture was heated to 85° C. Next, an aqueous aluminum chloride solution was added in an amount of 10 mass % when converted to Al₂O₃ with respect to the silica particles, and the pH was adjusted to 5.5 by using an aqueous sodium hydroxide solution. Afterwards, the mixture was maintained while being stirring for 30 minutes, and then, the mixture was filtered and the residue on the filter medium was washed with water to obtain a washed cake. Subsequently, the washed cake was dried at 120° C., and then, pulverized by using a media-type fine pulverizer. Finally, 40 g of the obtained powder was filled into a small mixer, 10 g of isobutyltrimethoxysilane was added and the mixture was mixed for 15 minutes. Subsequently, the mixture was again dried at 120° C. to prepare an inorganic external additive 1 (average particle diameter of 12 nm).

### (Preparation of Inorganic External Additive 2)

100 g of hydrophilic silica particles (AEROSIL 200: manufactured by Nippon Aerosil Co., Ltd., average primary particle diameter 12 nm) were dispersed in 2 L of water and the mixture was heated to 85° C. Next, an aqueous aluminum chloride solution was added in an amount of 10 mass % when converted to Al₂O₃ with respect to the silica particles, and the pH was adjusted to 5.5 by using an aqueous sodium hydroxide solution. Afterwards, the mixture was maintained while being stirring for 30 minutes, and then, the mixture was filtered and the residue on the filter medium was washed with water to obtain a washed cake. Subsequently, the washed cake was dried at 120° C., and then, pulverized by using a media-type fine pulverizer. Finally, 40 g of the obtained powder was filled into a small mixer, 12 g of isobutyltrimethoxysilane was added and the mixture was mixed for 15 minutes. Subsequently, the mixture was again dried at 120° C. to prepare an inorganic external additive 2 (average particle diameter of 12 nm).

### (Preparation of Inorganic External Additive 3)

100 g of hydrophilic silica particles (AEROSIL 200: manufactured by Nippon Aerosil Co., Ltd., average primary particle diameter 12 nm) were dispersed in 2 L of water and the mixture was heated to 85° C. Next, an aqueous aluminum chloride solution was added in an amount of 10 mass % when converted to Al₂O₃ with respect to the silica particles, and the pH was adjusted to 5.5 by using an aqueous sodium hydroxide solution. Afterwards, the mixture was maintained while being stirring for 30 minutes, and then, the mixture was filtered and the residue on the filter medium was washed with water to obtain a washed cake. Subsequently, the washed cake was dried at 120° C., and then, pulverized by using a media-type fine pulverizer to prepare an inorganic external additive 3 (average particle diameter of 12 nm).

### (Preparation of Inorganic External Additive 4)

100 g of hydrophilic silica particles (AEROSIL 200: manufactured by Nippon Aerosil Co., Ltd., average primary particle diameter 12 nm) were dispersed in 2 L of water and the mixture was heated to 85° C. Next, an aqueous zinc chloride solution was added in an amount of 10 mass % when converted to ZnO with respect to the silica particles, and the pH was adjusted to 8.0 by using an aqueous sodium hydroxide solution. Afterwards, the mixture was maintained while being stirring for 30 minutes, and then, the mixture was filtered and the residue on the filter medium was washed with water to obtain a washed cake. Subsequently, the washed cake was dried at 120° C., and then, pulverized by using a media-type fine pulverizer. Finally, 40 g of the obtained powder was filled into a small mixer, 10 g of isobutyltrimethoxysilane was added and the mixture was mixed for 15 minutes. Subsequently, the mixture was again dried at 120° C. to prepare an inorganic external additive 4 (average particle diameter of 12 nm).

### (Preparation of Inorganic External Additive 5)

100 g of hydrophilic silica particles (AEROSIL 200: manufactured by Nippon Aerosil Co., Ltd., average primary particle diameter 12 nm) were dispersed in 2 L of water and the mixture was heated to 85° C. Next, an aqueous magnesium chloride solution was added in an amount of 10 mass % when converted to MgO with respect to the silica particles, and the pH was adjusted to 5.0 by using an aqueous sodium hydroxide solution. Afterwards, the mixture was maintained while being stirring for 30 minutes, and then, the mixture was filtered and the residue on the filter medium was washed with water to obtain a washed cake. Subsequently, the washed cake was dried at 120° C., and then, pulverized by using a media-type fine pulverizer. Finally, 40 g of the obtained powder was filled into a small mixer, 10 g of isobutyltrimethoxysilane was added and the mixture was mixed for 15 minutes. Subsequently, the mixture was again dried at 120° C. to prepare an inorganic external additive 5 (average particle diameter of 12 nm).

### (Preparation of Inorganic External Additive 6)

100 g of hydrophilic silica particles (AEROSIL 200: manufactured by Nippon Aerosil Co., Ltd., average primary particle diameter 12 nm) were dispersed in 2 L of water and the mixture was heated to 85° C. Next, an aqueous iron chloride solution was added in an amount of 10 mass % when converted to FeO with respect to the silica particles, and the pH was adjusted to 8.5 by using an aqueous sodium hydroxide solution. Afterwards, the mixture was maintained while being stirring for 30 minutes, and then, the mixture was filtered and the residue on the filter medium was washed with water to obtain a washed cake. Subsequently, the washed cake was dried at 120° C., and then, pulverized by using a media-type fine pulverizer. Finally, 40 g of the obtained powder was filled into a small mixer, 10 g of isobutyltrimethoxysilane was added and the mixture was mixed for 15 minutes. Subsequently, the mixture was again dried at 120° C. to prepare an inorganic external additive 6 (average particle diameter of 12 nm).

### (Preparation of Inorganic External Additive 7)

100 g of hydrophilic silica particles (AEROSIL 90: manufactured by Nippon Aerosil Co., Ltd., average primary particle diameter 25 nm) were dispersed in 2 L of water and the mixture was heated to 85° C. Next, an aqueous aluminum chloride solution was added in an amount of 10 mass % when converted to Al₂O₃ with respect to the silica particles, and the pH was adjusted to 5.5 by using an aqueous sodium hydroxide solution. Afterwards, the mixture was maintained while being stirring for 30 minutes, and then, the mixture was filtered and the residue on the filter medium was washed with water to obtain a washed cake. Subsequently, the washed cake was dried at 120° C., and then, pulverized by using a media-type fine pulverizer. Finally, 40 g of the obtained powder was filled into a small mixer, 10 g of isobutyltrimethoxysilane was added and the mixture was mixed for 15 minutes. Subsequently, the mixture was again dried at 120° C. to prepare an inorganic external additive 7 (average particle diameter of 25 nm).

### (Preparation of Inorganic External Additive 8)

100 g of hydrophilic silica particles (AEROSIL 300: manufactured by Nippon Aerosil Co., Ltd., average primary particle diameter 8 nm) were dispersed in 2 L of water and the mixture was heated to 85° C. Next, an aqueous aluminum chloride solution was added in an amount of 10 mass % when converted to Al₂O₃ with respect to the silica particles, and the pH was adjusted to 5.5 by using an aqueous sodium hydroxide solution. Afterwards, the mixture was maintained while being stirring for 30 minutes, and then, the mixture was filtered and the residue on the filter medium was washed with water to obtain a washed cake. Subsequently, the washed cake was dried at 120° C., and then, pulverized by using a media-type fine pulverizer. Finally, 40 g of the obtained powder was filled into a small mixer, 10 g of isobutyltrimethoxysilane was added and the mixture was mixed for 15 minutes. Subsequently, the mixture was again dried at 120° C. to prepare an inorganic external additive 8 (average particle diameter of 8 nm).

### (Preparation of Inorganic External Additive 9)

100 g of hydrophilic silica particles (AEROSIL 50: manufactured by Nippon Aerosil Co., Ltd., average primary particle diameter 35 nm) were dispersed in 2 L of water and the mixture was heated to 85° C. Next, an aqueous aluminum chloride solution was added in an amount of 10 mass % when converted to Al₂O₃ with respect to the silica particles, and the pH was adjusted to 5.5 by using an aqueous sodium hydroxide solution. Afterwards, the mixture was maintained while being stirring for 30 minutes, and then, the mixture was filtered and the residue on the filter medium was washed with water to obtain a washed cake. Subsequently, the washed cake was dried at 120° C., and then, pulverized by using a media-type fine pulverizer. Finally, 40 g of the obtained powder was filled into a small mixer, 10 g of isobutyltrimethoxysilane was added and the mixture was mixed for 15 minutes. Subsequently, the mixture was again dried at 120° C. to prepare an inorganic external additive 9 (average particle diameter of 35 nm).

### (Preparation of Inorganic External Additive 10)

100 g of hydrophilic silica particles (AEROSIL 200: manufactured by Nippon Aerosil Co., Ltd., average primary particle diameter 12 nm) were dispersed in 2 L of water and the mixture was heated to 85° C. Next, an aqueous aluminum chloride solution was added in an amount of 10 mass % when converted to Al₂O₃ with respect to the silica particles, and the pH was adjusted to 5.5 by using an aqueous sodium hydroxide solution. Afterwards, the mixture was maintained while being stirring for 30 minutes, and then, the mixture was filtered and the residue on the filter medium was washed with water to obtain a washed cake. Subsequently, the washed cake was dried at 120° C., and then, pulverized by using a media-type fine pulverizer. Finally, 40 g of the obtained powder was filled into a small mixer, 10 g of isobutyltrimethoxysilane was added and the mixture was mixed for 15 minutes. Subsequently, the mixture was again dried at 120° C. to prepare an inorganic external additive 10 (average particle diameter of 12 nm).

### (Average Primary Particle Diameter)

The average primary particle diameter of the silica particles used in the preparation of the inorganic external additives 1 to 10 was measured by the following method.

A field emission scanning electron microscope (SU8230, manufactured by Hitachi High-Tech Corporation) was used to acquire a SEM image of the silica particles, and the number average particle diameter was measured by image analysis. First, a sample of silica particles was dispersed in tetrahydrofuran, and then, the solvent was removed on a substrate to dry the sample. The sample was observed by the above-mentioned SEM to acquire an image, and the maximum length of the primary particles was measured for each particle under the following measurement conditions. The average value of 50 particles was calculated and used as the average primary particle diameter of the silica particles.

### [SEM Measurement Conditions]

Acceleration voltage: 2.0 kV

Working distance (WD): 5.0 mm

Observation magnification: 100000 times

### (Measurement of HydrophobicityDegree)

The hydrophobicity degree of the prepared inorganic external additives 1 to 10 was measured by the following method.

0.2 g of each of the prepared inorganic external additives 1 to 10 was added to a beaker containing 50 ml of deionized water, and methanol was added dropwise to the beaker while stirring. As the methanol concentration in the beaker increases, the added external additive gradually settles. Therefore, the hydrophobicity degree (MeOH %) of each of the inorganic external additives is defined as the mass fraction of methanol in the mixed solution of methanol and water at the end point when the entire amount of the added external additive is settled.

### (Measurement of Volume Resistivity)

The volume resistivity of the prepared inorganic external additives 1 to 10 was measured by the following method.

First, a cell formed by a container made of a fluororesin accommodating two electrodes having a surface area of 2.5 cm×4 cm separated by a distance of 0.2 cm was prepared. Each of the inorganic external additives 1 to 10 was filled between the two electrodes mentioned above, and tapping was performed 10 times at a dropping height of 1 cm and a tapping speed of 30 times/min. Next, a DC voltage of 1,000 V was applied between the two electrodes between which the inorganic external additive was filled, and the resistance value r [Ω] after 30 seconds was measured by using a high resistance meter 4329A (manufactured by Yokogawa Hewlett-Packard Co., Ltd.). The volume resistivity [Ω*cm] of each of the inorganic external additives 1 to 10 was calculated by entering each of the measured resistance values r into the following formula.

$$r \times ( 2.5 \times 4 ) / 0.2 \qquad ( Formula )$$

The inorganic external additives 1 to 10 obtained above are described in detail in Table 1.

TABLE 1

| | Composition | | | | | |
|---|---|---|---|---|---|---|
| | | | | Average | Physical properties | |
| | Coated with | Type of | | particle | Hydrophobicity | Volume |
| | metal | metal | Coated with | diameter | degree | resistivity |
| | hydroxide | element | alkylsilane | (nm) | (MeOH %) | (Ω*cm) |
| Inorganic external | Yes | Aluminum | Yes | 12 | 60 | 1.10E+10 |
| additive 1 | | | | | | |
| Inorganic external | Yes | Aluminum | Yes | 12 | 65 | 1.20E+11 |
| additive 2 | | | | | | |
| Inorganic external | Yes | Aluminum | No | 12 | 55 | 8.50E+09 |
| additive 3 | | | | | | |
| Inorganic external | Yes | Zinc | Yes | 12 | 63 | 1.50E+10 |
| additive 4 | | | | | | |
| Inorganic external | Yes | Magnesium | Yes | 12 | 57 | 9.00E+09 |
| additive 5 | | | | | | |
| Inorganic external | Yes | Iron | Yes | 12 | 70 | 3.50E+10 |
| additive 6 | | | | | | |
| Inorganic external | Yes | Aluminum | Yes | 25 | 60 | 1.10E+10 |
| additive 7 | | | | | | |
| Inorganic external | Yes | Aluminum | Yes | 8 | 60 | 1.10E+10 |
| additive 8 | | | | | | |
| Inorganic external | Yes | Aluminum | Yes | 35 | 60 | 1.10E+10 |
| additive 9 | | | | | | |
| Inorganic external | Yes | Aluminum | Yes | 12 | 50 | 5.00E+09 |
| additive 10 | | | | | | |

### (Preparation of Amorphous Polyester Resin)

A reaction tank was equipped with a cooling tube, a stirrer, and a nitrogen inlet tube. The monomer species illustrated in Table 2 below and tetrabutoxy titanate as a condensation catalyst were filled into the reaction tank and the mixture was reacted at 230° C. for 6 hours, while removing the generated water by distillation under a nitrogen stream. Next, the mixture was reacted for 1 hour under a reduced pressure of 5 mm Hg to 20 mm Hg, to obtain an amorphous polyester resin to be used in the preparation of toner base particles 1 to 5 described below. In Table 2, “25 mol %” indicated for bisphenol A (2,2)ethylene oxide expresses the proportion in the alcohol component when the acid component is 50 mol % and the alcohol component is 50 mol %.

TABLE 2

| Acid component | Alcohol component | OH/COOH |
|---|---|---|
| Terephthalic acid | Bisphenol A (2,2) | 1.1 |
| | propylene oxide (5 mol %) | |
| | Bisphenol A (2,2) | |
| | ethylene oxide (25 mol %) | |
| | Ethylene glycol (20 mol %) | |

### (Preparation of Crystalline Polyester Resin)

A 5 L four-necked flask was equipped with a nitrogen inlet tube, a dehydration tube, a stirrer, and a thermocouple. Fumaric acid and 1,6-hexanediol were filled into the flask, so that the OH/COOH ratio was 0.9, and the mixture was reacted with titanium tetraisopropoxide (500 ppm with respect to the resin component) at 180° C. for 10 hours. Subsequently, the mixture was heated to 200° C. and reacted for 3 hours, and further reacted at a pressure of 8.3 kPa for 2 hours, to obtain a crystalline polyester resin having a melting point of 103° C. The crystalline polyester resin was used to prepare the toner base particles 1 to 5 described below.

### (Preparation of Toner Base Particles 1)

Amorphous polyester resin: 86.4 parts

Crystalline polyester resin: 4.8 parts

Aromatic petroleum resin (FTR-2140: manufactured by Mitsui Chemicals, Inc.): 4.8 parts

Hydrocarbon wax (SASOL WAX C80: manufactured by Sasol): 4.0 parts

Carbon black (#44, manufactured by Mitsubishi Chemical Corp.): 10 parts

According to the above-described preparation, toner raw materials were premixed by using a Henschel mixer (FM20B, manufactured by Mitsui Miike Kakoki Co., Ltd.), and then melted and kneaded at a temperature of 120° C. by using a twin-screw kneader (PCM-30, manufactured by Ikegai Iron Works Co., Ltd.).

The obtained kneaded product was rolled to a thickness of 2.7 mm by using a roller, and then, cooled to room temperature by using a belt cooler and coarsely ground to 200 μm to 300 μm by using a hammer mill. Subsequently, the obtained product was finely pulverized by using a supersonic jet pulverizer Labojet (manufactured by Nippon Pneumatic Mfg. Co., Ltd.). Afterwards, an air classifier (MDS-I, manufactured by Nippon Pneumatic Mfg. Co., Ltd.) was used to classify the particles while appropriately adjusting the louver opening so that the mass average particle diameter was 5.8+0.2 μm, to obtain the toner base particles 1.

### (Preparation of Toner Base Particles 2)

The toner base particles 2 were prepared by subjecting the toner base particles 1 to a spheronization treatment using hot air.

### (Preparation of Toner Base Particles 3)

Amorphous polyester resin: 91.2 parts

Aromatic petroleum resin (FTR-2140: manufactured by Mitsui Chemicals, Inc.): 4.8 parts

Hydrocarbon wax (SASOL WAX C80: manufactured by Sasol): 4.0 parts

Carbon black (#44, manufactured by Mitsubishi Chemical Corp.): 10 parts

According to the above-described preparation, toner raw materials were premixed by using a Henschel mixer (FM20B, manufactured by Mitsui Miike Kakoki Co., Ltd.), and then melted and kneaded at a temperature of 120° C. by using a twin-screw kneader (PCM-30, manufactured by Ikegai Iron Works Co., Ltd.).

The obtained kneaded product was rolled to a thickness of 2.7 mm by using a roller, and then, cooled to room temperature by using a belt cooler and coarsely ground to a size of 200 μm to 300 μm by using a hammer mill. Subsequently, the obtained product was finely pulverized by using a supersonic jet pulverizer Labojet (manufactured by Nippon Pneumatic Mfg. Co., Ltd.). Afterwards, an air classifier (MDS-I, manufactured by Nippon Pneumatic Mfg. Co., Ltd.) was used to classify the particles while appropriately adjusting the louver opening so that the mass average particle diameter was 5.8+0.2 μm, to obtain the toner base particles 3.

### (Preparation of Toner Base Particles 4)

Amorphous polyester resin: 91.2 parts

Crystalline polyester resin: 4.8 parts

Hydrocarbon wax (SASOL WAX C80: manufactured by Sasol): 4.0 parts

Carbon black (#44, manufactured by Mitsubishi Chemical Corp.): 10 parts

According to the above-described preparation, toner raw materials were premixed by using a Henschel mixer (FM20B, manufactured by Mitsui Miike Kakoki Co., Ltd.), and then melted and kneaded at a temperature of 120° C. by using a twin-screw kneader (PCM-30, manufactured by Ikegai Iron Works Co., Ltd.). The obtained kneaded product was rolled to a thickness of 2.7 mm by using a roller, and then, cooled to room temperature by using a belt cooler and coarsely ground to a size of 200 μm to 300 μm by using a hammer mill. Subsequently, the obtained product was finely pulverized by using a supersonic jet pulverizer Labojet (manufactured by Nippon Pneumatic Mfg. Co., Ltd.). Afterwards, an air classifier (MDS-I, manufactured by Nippon Pneumatic Mfg. Co., Ltd.) was used to classify the particles while appropriately adjusting the louver opening so that the mass average particle diameter was 5.8+0.2 μm, to obtain the toner base particles 4.

### (Preparation of Toner Base Particles 5)

Amorphous polyester resin: 86.4 parts

Crystalline polyester resin: 4.8 parts

Aromatic petroleum resin (FTR-2140: manufactured by Mitsui Chemicals, Inc.): 4.8 parts

Ester wax (WE-10: manufactured by NOF Corporation): 4.0 parts

Carbon black (#44, manufactured by Mitsubishi Chemical Corp.): 10 parts

According to the above-described preparation, toner raw materials were premixed by using a Henschel mixer (FM20B, manufactured by Mitsui Miike Kakoki Co., Ltd.), and then melted and kneaded at a temperature of 120° C. by using a twin-screw kneader (PCM-30, manufactured by Ikegai Iron Works Co., Ltd.).

The obtained kneaded product was rolled to a thickness of 2.7 mm by using a roller, and then, cooled to room temperature by using a belt cooler and coarsely ground to a size of 200 μm to 300 μm by using a hammer mill.

Subsequently, the obtained product was finely pulverized by using a supersonic jet pulverizer Labojet (manufactured by Nippon Pneumatic Mfg. Co., Ltd.). Afterwards, an air classifier (MDS-I, manufactured by Nippon Pneumatic Mfg. Co., Ltd.) was used to classify the particles while appropriately adjusting the louver opening so that the mass average particle diameter was 5.8+0.2 μm, to obtain the toner base particles 5.

### (Measurement of Average Circularity)

The wet flow-type particle size/shape analyzer FPIA-3000 and the analysis software FPIA-3000 Data Processing Program for FPIA version 00-10 (manufactured by Sysmex Corporation) were used to determine the average circularity of the toner base particles 1 to 5 by the following method.

A 100 mL glass beaker was used, and 0.1 to 0.5 mL of a 10% aqueous solution of the alkylbenzene sulfonate salt NEOGEN SC-A (manufactured by DKS Co., Ltd.) and 0.1 to 0.5 g of the toner base particles were added to the beaker. Afterwards, a micro spatula was used to stir the mixture and 80 mL of deionized water were added. Next, an ultrasonic disperser UH-50 (manufactured by SMT Co., Ltd.) was used to disperse the mixture for 1 minute under conditions including 20 kHz and 50 W/10 cm³. Subsequently, the mixture was dispersed for a total of 5 minutes to obtain a measurement sample. Here, a measurement sample having a particle concentration of 4000 to 8000 particles/10-3 cm³ was used to measure the average circularity of the toner base particles.

Note that the average circularity of the toner base particles may be used as the average circularity of a toner in which the toner base particles are used.

The toner base particles 1 to 5 obtained above are described in detail in Table 3.

TABLE 3

| | Crystalline | Aromatic | | |
|---|---|---|---|---|
| | polyester resin | petroleum resin | Type of wax | Average circularity |
| Base particles 1 | Contained | Contained | Hydrocarbon wax | 0.94 |
| Base particles 2 | Contained | Contained | Hydrocarbon wax | 0.97 |
| Base particles 3 | Not contained | Contained | Hydrocarbon wax | 0.94 |
| Base particles 4 | Contained | Not contained | Hydrocarbon wax | 0.94 |
| Base particles 5 | Contained | Contained | Ester wax | 0.94 |

### (Examples 1 to 13, Comparative Examples 1 and 2)

Toners 1 to 15 were prepared by using a Henschel mixer to stir and mix 100 parts by mass of toner base particles, 1 part by mass of HDK-2000 (Clariant AG) as hydrophobic silica particles, and 0.5 parts by mass of an inorganic external additive. Table 4 illustrates the combinations of the toner base particles 1 to 5 and the inorganic external additives 1 to 10 used in the toners 1 to 15.

TABLE 4

| Examples/Comparative Examples | | Toner preparation | |
|---|---|---|---|
| | Type of toner | Toner base particles | Type of inorganic external additive |
| Example 1 | Toner 1 | Base particles 1 | Inorganic external additive 1 |
| Example 2 | Toner 2 | Base particles 1 | Inorganic external additive 2 |
| Example 3 | Toner 3 | Base particles 2 | Inorganic external additive 1 |
| Example 4 | Toner 4 | Base particles 1 | Inorganic external additive 3 |
| Example 5 | Toner 5 | Base particles 1 | Inorganic external additive 4 |
| Example 6 | Toner 6 | Base particles 1 | Inorganic external additive 5 |
| Example 7 | Toner 7 | Base particles 1 | Inorganic external additive 6 |
| Example 8 | Toner 8 | Base particles 1 | Inorganic external additive 7 |
| Example 9 | Toner 9 | Base particles 1 | Inorganic external additive 8 |
| Example 10 | Toner 10 | Base particles 1 | Inorganic external additive 9 |
| Example 11 | Toner 11 | Base particles 3 | Inorganic external additive 1 |
| Example 12 | Toner 12 | Base particles 4 | Inorganic external additive 1 |
| Example 13 | Toner 13 | Base particles 5 | Inorganic external additive 1 |
| Comparative Example 1 | Toner 14 | Base particles 1 | — |
| Comparative Example 2 | Toner 15 | Base particles 1 | Inorganic external additive 10 |

### (Toner Developers 1 to 15)

Five mass % of each of the toners 1 to 15 and 95 mass % of coating ferrite carrier were uniformly mixed at 48 rpm for 5 minutes by using a TURBULA mixer (manufactured by Willy & Bacchofen (WAB) AG), to prepare toner developers 1 to 15.

The toners 1 to 15 and the toner developers 1 to 15 prepared as described above were used to evaluate, by the following evaluation methods, the low-temperature fixability, the heat-resistant storage stability, the charging stability, and the presence of abnormal images.

### (Evaluation of Low-temperature Fixability)

The toner developers 1 to 15 were placed in a copying machine (RICOH MPC 6003) manufactured by Ricoh Co., Ltd., and images were output. A solid image having an adhesion amount of 0.4 mg/cm² was output on a paper (Type 6200 manufactured by Ricoh Co., Ltd.) via exposure, development, and transfer steps. The linear speed in the fixing step was 256 mm/sec. The images were sequentially output in 5° C. fixing temperature increments, and the lower limit temperature at which cold offset does not occur (lower limit fixing temperature: low-temperature fixability) was measured. The NIP width of the fixing device was 11 mm. Among the following evaluation criteria, evaluation results indicated as “excellent” and “good” were determined to be sufficient for practical use, and evaluation results indicated as “fail” were determined to be insufficient for the present embodiment.

### —Evaluation Criteria of Low-temperature Fixability—

Excellent: Less than 120° C.

Good: 120° C. or more and less than 130° C.

Fail: 130° C. or more

### (Evaluation of Heat-resistant Storage Stability)

The toners 1 to 15 were stored under conditions including 50° C. for 24 hours, and the penetration was measured according to JIS K2235 (25° C.). A penetrometer VR-5610 (Shimadzu Corporation) was used as a penetration measurement device. Among the following evaluation criteria, evaluation results indicated as “excellent” and “good” were determined to be sufficient for practical use, and evaluation results indicated as “fail” were determined to be insufficient for the present embodiment.

### —Evaluation Criteria of Heat-resistant Storage Stability—

Excellent: 25 mm or more

Good: 20 mm or more and less than 25 mm

Fail: Less than 20 mm

### (Evaluation of Charging Stability)

The toner developers 1 to 15 were placed in a copying machine IMAJIO MF-6550 having low-temperature fixability manufactured by Ricoh, and 100,000 test charts having an image area of 6% were copied to evaluate the degree of decrease in the charge amount. Among the following evaluation criteria, evaluation results indicated as “excellent” and “good” were determined sufficient for practical use, and evaluation results indicated as “fail” were determined to be insufficient for the present embodiment.

### —Evaluation Criteria of Charging Stability—

Excellent: Very little decrease in charge amount and excellent durability

Good: Little decrease in charge amount and better durability than in conventional toner

Fail: Low durability equivalent to or lower than in conventional toner

### (Evaluation of Presence of Abnormal Images)

The toner developers 1 to 15 were placed in a copying machine IMAJIO MF-6550 having low-temperature fixability manufactured by Ricoh, and in a high-temperature and high-humidity environment (27° C., 80%), Askul Super White+sheets were used to copy 200,000 test charts having an image area of 6%, to evaluate the presence of abnormal images such as black streaks. Among the following evaluation criteria, evaluation results indicated as “excellent” and “good” were determined to be sufficient for practical use, and evaluation results indicated as “fail” were determined to be insufficient for the present embodiment.

### —Evaluation Criteria of Presence of Abnormal Images—

Excellent: Abnormal images occur at a rate of less than 10%

Good: Abnormal images occur at a rate of 10% or more and less than 20%

Fail: Abnormal images occur at a rate of 20% or more

The evaluation results for each toner are mentioned below.

TABLE 5

| | | Evaluation results | | | |
|---|---|---|---|---|---|
| Examples/Comparative Examples | | Low-temperature | Heat-resistant | Charging | Abnormal |
| | Type of toner | fixability | storage stability | stability | images |
| Example 1 | Toner 1 | Excellent | Excellent | Excellent | Excellent |
| Example 2 | Toner 2 | Excellent | Excellent | Good | Excellent |
| Example 3 | Toner 3 | Excellent | Excellent | Excellent | Good |
| Example 4 | Toner 4 | Excellent | Excellent | Excellent | Good |
| Example 5 | Toner 5 | Excellent | Excellent | Excellent | Excellent |
| Example 6 | Toner 6 | Excellent | Excellent | Excellent | Excellent |
| Example 7 | Toner 7 | Excellent | Excellent | Good | Excellent |
| Example 8 | Toner 8 | Excellent | Excellent | Excellent | Excellent |
| Example 9 | Toner 9 | Excellent | Good | Excellent | Good |
| Example 10 | Toner 10 | Good | Excellent | Excellent | Excellent |
| Example 11 | Toner 11 | Good | Excellent | Excellent | Excellent |
| Example 12 | Toner 12 | Excellent | Good | Good | Excellent |
| Example 13 | Toner 13 | Excellent | Good | Good | Excellent |
| Comparative Example 1 | Toner 14 | Excellent | Good | Fail | Fail |
| Comparative Example 2 | Toner 15 | Excellent | Excellent | Good | Fail |

The evaluation results of the toners used in Examples 1 to 13 were “excellent” or “good” for the low-temperature fixability, the heat-resistant storage stability, the charging stability, and the presence of abnormal images, and thus, indicated results sufficient for practical use.

The toner of Comparative Example 1 did not contain silica that was at least partially coated with a metal hydroxide, and thus, it was not possible to ensure the charging stability and abnormal images were likely to occur.

The toner of Comparative Example 2 contained silica that was at least partially coated with a metal hydroxide, but the hydrophobicity degree of the silica was lower than 55 (MeOH %), so that it was not possible to impart suitable cleaning performance, and abnormal images were likely to occur.

Aspects of the present invention include the following, for example.

According to a first aspect, a toner comprises an amorphous polyester resin, a wax, and an external additive, the external additive comprises a partially-metal-hydroxide-coated silica that is a silica partially coated with a metal hydroxide, and the a partially-metal-hydroxide-coated silica has a hydrophobicity degree of 55 (MeOH %) or more.

According to a second aspect, in the toner according to the first aspect, the a partially-metal-hydroxide-coated silica has a volume resistivity of 1.0E+11 (Ω*cm) or less.

According to a third aspect, in the toner according to the first aspect or the second aspect, the toner has an average circularity of from 0.930 to 0.960.

According to a fourth aspect, in the toner according to any one of the first to third aspects, the partially-metal-hydroxide-coated silica is partially coated with an alkylsilane.

According to a fifth aspect, in the toner according to any one of the first to fourth aspects, the metal hydroxide comprises a hydroxide of at least one among aluminum, zinc, iron, and magnesium.

According to a sixth aspect, in the toner according to any one of the first to fifth aspects, the partially-metal-hydroxide-coated silica has an average particle diameter of from 10 to 30 nm.

According to a seventh aspect, the toner according to any one of the first to sixth aspects further includes at least one of a crystalline polyester resin and an aromatic petroleum resin.

According to an eighth aspect, an image forming apparatus includes:
an electrostatic latent image bearer,
an electrostatic latent image forming unit to form an electrostatic latent image on the electrostatic latent image bearer,
a developing unit containing the toner according to any one of the first to seventh aspects, to develop the electrostatic latent image with the toner to form a toner image,
a transfer unit to transfer the toner image onto a recording medium, and
a fixing unit that to fix the transferred toner image on the recording medium.

According to a ninth aspect, an image forming method includes
forming an electrostatic latent image on an electrostatic latent image bearer,
developing the electrostatic latent image with the toner according to any one of the first to seventh aspects to form a toner image,
transferring the toner image onto a recording medium, and
fixing the transferred toner image on the recording medium.

According to a tenth aspect, a method of manufacturing a printed matter includes forming the toner image on the recording medium by the image forming method according to the ninth aspect.

The toner according to any one of the first to seventh aspects, the image forming apparatus according to the eighth aspect, the image forming method according to the ninth aspect, and the method of manufacturing a printed matter according to the tenth aspect can solve the above-described conventional problems and achieve the object of the present invention.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A toner, comprising:
an amorphous polyester resin;
a wax; and
an external additive, wherein
the external additive comprises a partially-metal-hydroxide-coated silica that is a silica partially coated with a metal hydroxide, and
the partially-metal-hydroxide-coated silica has a hydrophobicity degree of 55 (MeOH %) or more.

2. The toner according to claim 1, wherein the partially-metal-hydroxide-coated silica has a volume resistivity of 1.0E+11 (Ω*cm) or less.

3. The toner according to claim 1, wherein the toner has an average circularity of from 0.930 to 0.960.

4. The toner according to claim 1, wherein the partially-metal-hydroxide-coated silica is partially coated with an alkylsilane.

5. The toner according to claim 1, wherein the metal hydroxide comprises a hydroxide of at least one among aluminum, zinc, iron, and magnesium.

6. The toner according to claim 1, wherein the partially-metal-hydroxide-coated silica has an average particle diameter of from 10 to 30 nm.

7. The toner according to claim 1, further comprising at least one of a crystalline polyester resin and an aromatic petroleum resin.

8. An image forming apparatus, comprising:
an electrostatic latent image bearer;
an electrostatic latent image forming unit to form an electrostatic latent image on the electrostatic latent image bearer;
a developing unit containing the toner according to claim 1, to develop the electrostatic latent image with the toner to form a toner image;
a transfer unit to transfer the toner image onto a recording medium; and
a fixing unit to fix the transferred toner image on the recording medium.

9. An image forming method, comprising:
forming an electrostatic latent image on an electrostatic latent image bearer;
developing the electrostatic latent image with the toner according to claim 1 to form a toner image;
transferring the toner image onto a recording medium; and
fixing the transferred toner image on the recording medium.

10. A method of manufacturing a printed matter, the method comprising:
forming the toner image on the recording medium by the image forming method according to claim 9.
